(19) United States
(12) Patent Application Publication
(10) Pub. No.: US 2017/0171510 A1
(43) Pub. Date: Jun. 15, 2017

(54) METHOD AND DEVICE FOR LEAVING VIDEO MESSAGE

(71) Applicants: Le Holdings (Beijing) Co., Ltd., Beijing (CN); LE SHI ZHI XIN ELECTRONIC TECHNOLOGY (TIANJIN) LIMITED, Beijing (CN)

(72) Inventors: Jin ZHU, Beijing (CN); Xun XU, Beijing (CN); Liang PENG, Beijing (CN)

(21) Appl. No.: 15/247,620

(22) Filed: Aug. 25, 2016

Related U.S. Application Data
(63) Continuation of application No. PCT/CN2016/088097, filed on Jul. 1, 2016.

(30) Foreign Application Priority Data
Dec. 15, 2015 (CN) 201510946631.7

(51) Int. Cl. H04N 7/14; H04M 3/53

(52) U.S. Cl. CPC H04N 7/147; H04M 3/5315

(57) ABSTRACT

Disclosed are a method and device for leaving a video message, wherein the method includes: acquiring video message information of a calling terminal when a user determines to leave a video message, and sending the video message information and an identifier of a called terminal to the server, such that the server sends the video message information to the called terminal. According to the present disclosure, when a calling request sent by a calling party is not answered within preset time, a video message can be recorded, and is saved to the server, such that a called party can obtain the video message immediately when being online, and can immediately know a call subject according to the video message. Therefore, convenience is brought to both parties of a call, and the time cost is saved.

### CROSS-REFERENCE TO RELATED APPLICATIONS

This application is a continuation of International Application No. PCT/CN20161088097, filed on Jul. 1, 2016, which is based upon and claims priority to Chinese Patent Application No. 201510946631.7, filed on Dec. 15, 2015. The disclosure of each of the foregoing application is incorporated herein by reference in its entirety.

### TECHNICAL FIELD

The present disclosure relates to the field of smart terminal application, and specifically relate to a method and device for leaving a video message, a terminal and a server.

### BACKGROUND

With the popularization of smart TVs and smart phones and the rapid development of networks, communications between people depend on networks more and more; videos calls are especially convenient. However, since TVs have large screens and high resolutions, the proportion of video calls by means of network TVs is greatly increased.

At present, a video call can be realized in such a manner that a user turns on a network TV and originates a video call invitation to an opposite party, and the opposite party clicks to answer. However, it is required that a video call can be connected only when the TVs of both parties are online; when the opposite party is not online or does not answer, a prompt of no answer may be given to the user. This case may lead to a problem that a plurality of calls made by the calling party are not answered, and the called party cannot know the subject of the calls made by the opposite party after being online. It is inconvenient for both parties of the call, and time is wasted.

### SUMMARY

Aiming at the defects in the prior art, embodiments of the present disclosure provide a method and device for leaving a video message, a terminal and a server, which enable a video message function when a call is not answered, and thus are convenient for both parties of the call. The time cost is saved.

In order to solve the above technical problems, the embodiments of the present disclosure provide the following technical solutions:

According to a first aspect, the present invention provides a method for leaving a video message. The method includes:

acquiring video message information of a calling terminal when a user determines to leave a video message;

sending the video message information and an identifier of a called terminal to a server, such that the server sends the video message information to the called terminal.

According to a second aspect, the present invention also provides a method for leaving a video message. The method includes:

when a server receives video message information and an identifier of a called terminal that are sent by a calling terminal, saving the video message information;

sending the video message information to the called terminal upon detecting that the called terminal is online.

According to a third aspect, the present invention also provides a device for leaving a video message, comprising: at least one processor; and a memory for storing instructions executable by the processor; wherein the at least one processor is configured to: acquire video message information of a calling terminal when a user determines to leave a video message; send the video message information and an identifier of a called terminal to a server, such that the server sends the video message information to the called terminal.

According to a fourth aspect, the present invention also provides a device for leaving a message, comprising at least one processor; and a memory for storing instructions executable by the processor, wherein the at least one processor is configured to: receive video message information and an identifier of a called terminal that are sent by a calling terminal; save the video message information; send the video message information to the called terminal upon detecting that the called terminal is online.

According to a fifth aspect, the present invention also provides a non-volatile computer readable storage medium, where the non-volatile computer readable storage medium stores a computer instruction, and a computer executes the computer instruction to execute the following operations:

acquiring video message information of a calling terminal when a user determines to leave a video message;

sending the video message information and an identifier of a called terminal to a server, such that the server sends the video message information to the called terminal.

According to a sixth aspect, the present invention provides a non-volatile computer readable storage medium, where the non-volatile computer readable storage medium stores a computer instruction, and a computer executes the computer instruction to execute the following operations:

when video message information and an identifier of a called terminal that are sent by a calling terminal are received by a server, saving the video message information;

sending the video message information to the called terminal upon detecting that the called terminal is online.

It can be seen from the above technical solutions that the present disclosure provides the method and device for leaving a video message. When a calling request sent by a calling party is not answered within preset time, a video message can be recorded, and is saved to the server, such that a called party can obtain the video message immediately when being online, and can immediately know a call subject according to the video message. Therefore, convenience is brought to both parties of a call, and the time cost is saved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow schematic diagram of a method for leaving a video message provided by an embodiment of the present disclosure.

FIG. 2 is a flow schematic diagram of a method for leaving a video message provided by another embodiment of the present disclosure.

FIG. 3 is a flow schematic diagram of a method for leaving a video message provided by yet another embodiment of the present disclosure.

FIG. 4 is a structural schematic diagram of a device for leaving a video message provided by an embodiment of the present disclosure.

FIG. 5 is a structural schematic diagram of a device for leaving a video message provided by another embodiment of the present disclosure.

FIG. 6 is a structural schematic diagram of a terminal provided by an embodiment of the present disclosure.

FIG. 7 is a structural schematic diagram of a server provided by an embodiment of the present disclosure.

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part, but not all, of the embodiments of the present disclosure. All of other embodiments, obtained by a person of ordinary skill in the art based on the embodiments in the present disclosure without any creative effort should fall into the protection scope of the present disclosure.

FIG. 1 shows the flow schematic diagram of the method for leaving a video message provided by an embodiment of the present disclosure. As shown in FIG. 1, the method includes the following steps:

S101: video message information of a calling terminal is acquired when a user determines to leave a video message.

It needs to be noted that the calling terminal and a called terminal in this embodiment are both terminals capable of making voice calls or video calls; for example, they can be such devices as network TVs, cellphones, tablet PCs, PDAs, notebook computers or the like, and of course, may also be other devices having similar functions, which is not limited in this embodiment.

In this step, if the user determines to leave the video message, the calling terminal acquires data of a camera and a microphone of the calling terminal to obtain the video message information; alternatively, the calling terminal obtains pre-recorded video information as the video message information.

S102: the video message information and an identifier of a called terminal are sent to a server, such that the server sends the video message information to the called terminal.

Specifically, the calling terminal sends the video message information to the server, and the server saves the video message information, detects in real time whether the called terminal is online, and sends the video message to the called terminal when the called terminal is online. It needs to be noted that the calling terminal sends the identifier of the called terminal along with the video message information to the server, such that the server sends the video message information to the corresponding called terminal.

The identifier of the called terminal may be a cellphone number, an account number, an identity (ID), an Internet protocol (IP) or the like. The identifier is used for uniquely identifying the corresponding called terminal.

For example, if the user determines to leave the video message, the calling terminal displays recording buttons for recording on an interface thereof, specifically including a start button and an end button. Once the start button is clicked, it starts to record a video; when the recording of the video is completed, the end button is clicked. The calling terminal detects recording completed information according to the end button, and then generates and sends the video message information to the server.

It thus can be seen that in this embodiment, if a calling request sent by the calling party is not answered within preset time, the video message is recorded and saved to the server, such that the called party can obtain the video message immediately when being online, and can immediately know a call subject according to the video message. Therefore, convenience is brought to both parties of a call, and the time cost is saved.

In this embodiment, the method further includes the following step before step S101:

A prompt message for prompting the user to leave a video message is sent if the called terminal does not respond to a calling request sent by the calling terminal within a first preset time period.

It can be understood that the calling request typically includes an identifier of the calling terminal and the identifier of the called terminal. For example, the identifier of the calling terminal and the identifier of the called terminal may be cellphone numbers, account numbers, identities (ID), Internet protocols (IP) or the like. The identifiers are used for uniquely identifying the corresponding terminals.

Specifically, if the called terminal does not respond within the first preset time period, the calling terminal displays a prompt message that “the called terminal does not answer; do you want to leave a video message?”, and determines whether to leave a video message according to user instructions. It can be understood that the voice for no response of the called terminal may include being not online, no answer, and the like.

It needs to be noted that before the step of sending the prompt message for prompting the user to leave a video message, the method also includes the following steps:

S001: after the calling terminal sends the calling request to the server, a detection is performed on whether a first message sent by the server is received.

Wherein, the first message is a message indicating no response to the calling request.

It can be understood that the method for leaving a video message provided by this embodiment involves interactions among the calling terminal, the called terminal and the server. Specifically, the calling terminal sends the calling request to the called terminal via the server, and the server receives the calling request and sends it to the called terminal, and judges whether the called terminal responds, i.e., answers, within the first preset time; if the called terminal does not respond, the server sends the first message to the calling terminal.

S002, if the first message is received, it is determined that the called terminal does not respond to the calling request within the first preset time, and the step of sending the prompt message for prompting the user to leave the video message is executed.

Specifically, if the calling terminal receives the above first message, it indicates that the called terminal does not respond to the calling request within the preset time period, and the calling terminal prompts the user to leave the video message.

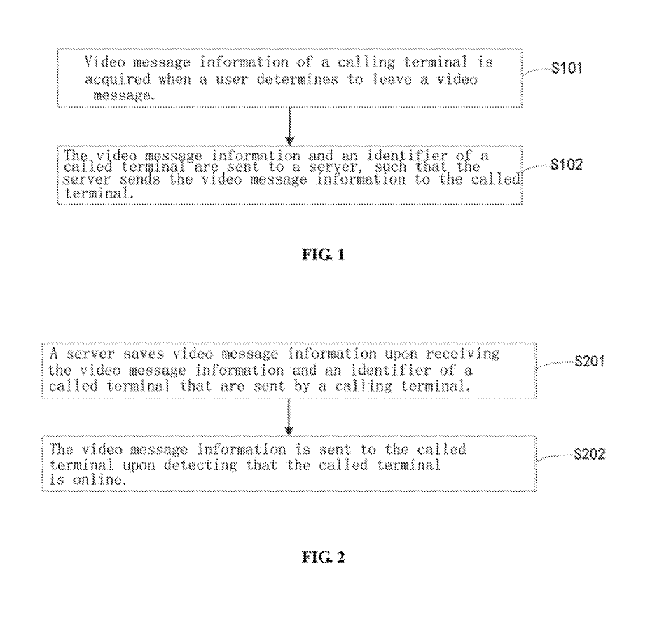

FIG. 2 shows the flow schematic diagram of the method for leaving a video message provided by another embodiment of the present disclosure. As shown in FIG. 2, the method includes the following steps:

S201: a server saves video message information upon receiving the video message information and an identifier of a called terminal that are sent by a calling terminal.

Specifically, the server saves the video message information first after receiving it, and sends the video message information to the called terminal after the called terminal is online.

It can be understood that the server also needs to save an identifier of the calling terminal and the identifier of the called terminal in addition to the video message information.

S202, the video message information is sent to the called terminal upon detecting that the called terminal is online.

Specifically, the server detects in real time whether the terminal corresponding to the identifier of the called terminal is online after saving the video message information. When the called terminal is online, the video message information is sent to the called terminal.

In this step, when the called terminal is online, the server sends a second message to the called terminal; the second message is a notification message for informing a user of receiving a video message; when the user corresponding to the called terminal determines to receive the video message, the server sends the saved video message information to the called terminal. Therefore, the called terminal can immediately receive the video message information.

In this embodiment, before step S201, the method also includes the following steps not shown in FIG. 2:

A01, the server sends a calling request sent by the calling terminal to the called terminal upon receiving the calling request.

Specifically, when the server receives the calling request, it sends, according to the identifier of the called terminal in the calling request, the calling request to the terminal corresponding to the identifier, i.e., the called terminal.

A02, if the called terminal does not respond to the calling request within a first preset time period, a first message is sent to the calling terminal, such that the calling terminal prompts the user to leave the video message.

Wherein, the first message is a message indicating no response to the calling request, i.e., that the calling request is not answered by the called terminal.

Specifically, after the server sends the calling request to the called terminal, timing is started, and a judgment is made on whether the called terminal responds within the first preset time period; if the called terminal responds, it is directly connected with the calling terminal for a video call or a voice call. If the called terminal does not respond, the first message is sent to the calling terminal to prompt the user of the calling terminal to record a video message. If the user determines not to record the video message, the video call is ended directly; if the user determines to record the video message, step S201 is carried out.

It thus can be seen that in this embodiment, the server judges whether the calling request is answered by the called terminal within the preset time after sending the calling request to the called terminal; if the calling request is not answered, the first message is sent to the calling terminal to prompt the calling terminal to leave a video message, and the video message is saved until the called terminal is online. Thus, once the called terminal is online, it can immediately receive the video message sent by the calling terminal. Convenience is brought for both parties of a call; both parties of a call do not need to make a plurality of calls, and the time cost is saved.

It needs to be noted that the method for leaving a video message of this embodiment also includes the following step not shown in FIG. 2:

The video message information is deleted if the called terminal is not online within a second preset time period.

It thus can be seen that the video message information is deleted if the called terminal is not online at an interval of the second preset time period, such that a memory for storing the video message information in the server is released, thereby preventing the video message information from occupying the capacity of the memory for a long time.

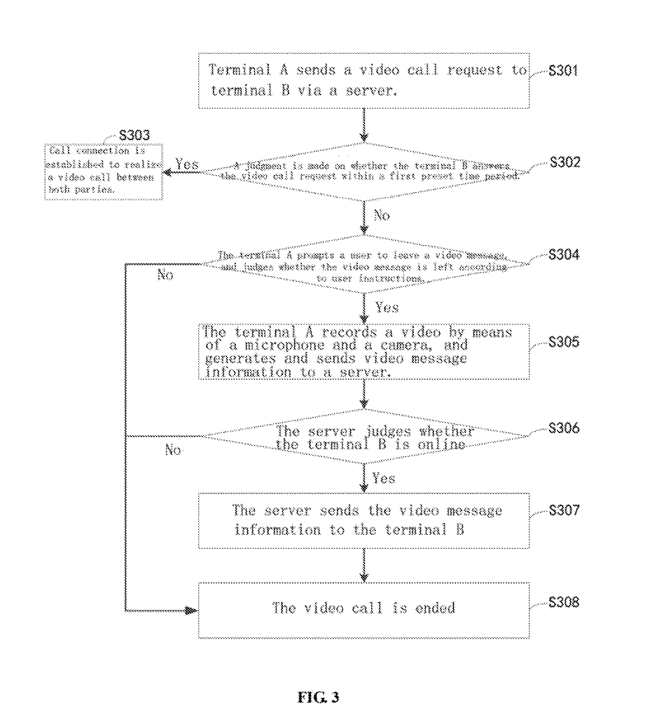

In order to more clearly illustrate the technical solutions of the present disclosure, a method for leaving a video message will be illustrated below by taking a video call as an example. Terminal A is the calling terminal in the above embodiments, while terminal B is the called terminal in the above embodiments. As shown in FIG. 3, the method specifically include the following steps:

S301: The terminal A sends a video call request to the terminal B via a server.

S302: a judgment is made on whether the terminal B answers the video call request within a first preset time period; if so, step S303 is executed; or otherwise, step S304 is executed.

Specifically, the terminal A judges whether the terminal B answers the video call request by means of the server. Specifically, the server judges whether the terminal B answers the video call request within the preset time; if so, step S303 is directly executed for the call; or otherwise, the server sends a notification message of leaving a video message to the terminal A. According to the received notification message, the terminal A can determine that the terminal B does not answer the video call request within the first preset time period.

Step 303: call connection is established to realize a video call between both parties.

Step 304: the terminal A prompts a user to leave a video message, and judges whether the video message is left according to user instructions; if so, step S305 is executed; or otherwise, step S308 is executed.

S305: the terminal A records a video by means of a microphone and a camera, and generates and sends video message information to the server.

S306: the server judges whether the terminal B is online; if so, step S307 is executed; or otherwise, step S308 is executed.

S307: the server sends the video message information to the terminal B.

S308: the video call is ended.

It needs to be noted that the above first and second preset time periods can be adjusted as required.

In regard to the method embodiments, for the sake of simple descriptions, they are all expressed as combinations of a series of actions; however, a person skilled in the art should know that the embodiments of the present disclosure are not limited by the described order of actions, because some steps may be carried out in other orders or simultaneously according to the embodiments of the present disclosure. Besides, a person skilled in the art should also know that the embodiments described in the description are all optional embodiments, and the actions involved therein are not necessary for the embodiments of the present disclosure.

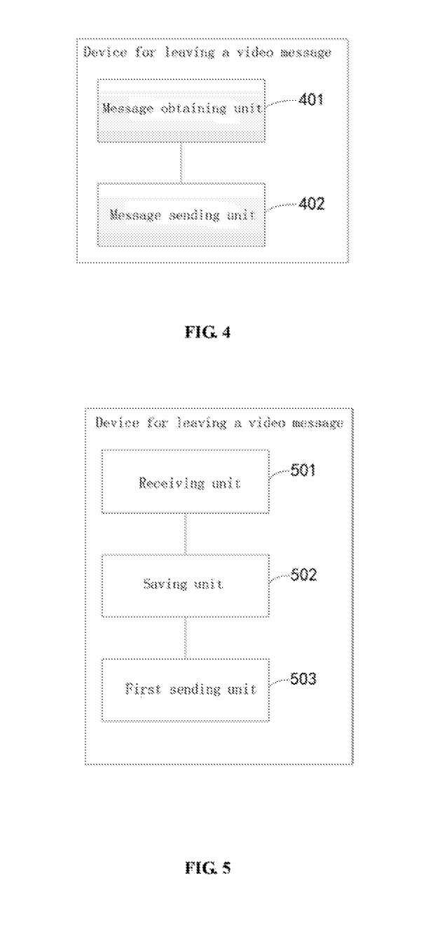

FIG. 4 shows the structural schematic diagram of the device for leaving a video message provided by an embodiment of the present disclosure. As shown in FIG. 4, the device includes a message obtaining unit 401 and a message sending unit 402, wherein

the message sending unit 401 is configured to acquire video message information of a calling terminal when a user determines to leave a video message;

the message sending unit 402 is configured to send the video message information and an identifier of a called terminal to a server, such that the server sends the video message information to the called terminal.

In this embodiment, the message sending unit 401 is configured to:

acquire data of a camera and a microphone of the calling terminal to obtain the video message information.

In this embodiment, the device also includes: a message prompting unit configured to:

when the called terminal does not respond to a calling request sent by the calling terminal within a first preset time period, send a prompt message for prompting the user to leave a video message.

In this embodiment, the device also includes: a first detecting unit configured to:

detect whether a first message sent by the server is received after sending the calling request to the server, wherein the first message is a message indicating no response to the calling request;

determine that the called terminal does not respond to the calling request within the first preset time if the first message is received.

The device for leaving a video message of this embodiment can be used to execute the method for leaving a video message of the above first embodiment, and is similar to the method in principle and technical effects, which are not redundantly described herein.

Another embodiment of the present disclosure provides a terminal, including the above device for leaving a video message. For example, the terminal can be a network TV, a smart phone or the like.

The terminal of this embodiment includes the device for leaving a video message in the above embodiment; therefore, when a call request is not answered within preset time, the terminal of this embodiment records a video message and saves the video message to the server, such that the called party can obtain the video message immediately when being online, and can immediately know a call subject according to the video message. As a result, convenience is brought to both parties of a call, and the time cost is saved.

FIG. 5 shows the structural schematic diagram of the device for leaving a video message provided by an embodiment of the present disclosure. As shown in FIG. 5, the device includes a receiving unit 501, a saving unit 502 and a first sending unit 503, wherein

the receiving unit 501 is configured to receive video message information and an identifier of a called terminal that are sent by a calling terminal;

the saving unit 502 is configured to save the video message information;

the first sending unit 503 is configured to send the video message information to the called terminal upon detecting that the called terminal is online.

In this embodiment, the device further includes:

a second sending unit configured to send a calling request sent by the calling terminal to the called terminal when the calling request is received;

a third sending unit configured to send a first message to the calling terminal when the called terminal does not respond to the calling request within a first preset time period, such that the calling terminal prompts a user to leave a video message, wherein the first message is a message indicating no response to the calling request.

In this embodiment, the device further includes: a second detecting unit configured to:

detect whether the called terminal is online;

send the video message information to the called terminal when the called terminal is online.

In this embodiment, the device further includes: a deleting unit configured to:

delete the video message information if the called terminal is not online within a second preset time period.

The device for leaving a video message of this embodiment can be used to execute the method for leaving a video message of the above first embodiment, and is similar to the method in principle and technical effects, which are not redundantly described herein.

Another embodiment of the present disclosure provides a server, including the above device for leaving a video message.

The server of this embodiment includes the device for leaving a video message in the above embodiment; therefore, after sending the calling request to the called terminal, the server of this embodiment judges whether the calling request is answered by the called terminal within the preset time; if the calling request is not answered, the server sends the first message to the calling terminal to prompt the calling terminal to leave a video message, and saves the video message until the called terminal is online. Thus, once the called terminal is online, it can immediately receive the video message sent by the calling terminal. As a result, convenience is brought to both parties of a call; both parties of a call also do not need to make a plurality of calls, and the time cost is saved.

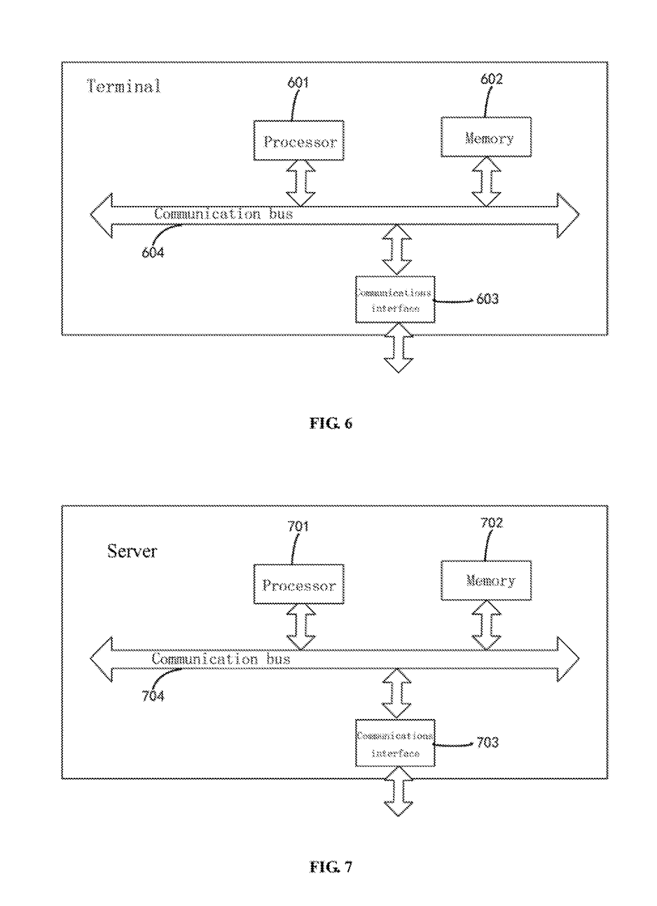

FIG. 6 shows a structural block diagram of a terminal of another embodiment of the present disclosure.

By referring to FIG. 6, the terminal includes:

a processor 601, a memory 602, a communications interface 603 and a bus 604, wherein

the processor 601, the memory 602 and the communications interface 603 implement communications with each other by means of the bus 604;

the communications interface 603 is used for transmitting information between the terminal and a server,

the processor 601 is used for calling logical instructions in the memory 602 to execute the following method:

acquiring video message information of a calling terminal when a user determines to leave a video message; sending the video message information and an identifier of a called terminal to a server, such that the server sends the video message information to the called terminal.

By referring to FIG. 1, another embodiment of the present disclosure discloses a computer program, including program codes for executing the following operations:

acquiring video message information of a calling terminal when a user determines to leave a video message;

sending the video message information and an identifier of a called terminal to a server, such that the server sends the video message information to the called terminal.

Another embodiment of the present disclosure discloses a storage medium, used to store the computer program as described in the above embodiment.

FIG. 7 shows a structural block diagram of a server of another embodiment of the present disclosure.

By referring to FIG. 7, the terminal includes:

a processor 701, a memory 702, a communications interface 703 and a bus 704, wherein

the processor 701, the memory 702 and the communications interface 703 implement communications with each other by means of the bus 704;

the communications interface 703 is used for transmitting information between the server and a terminal;

the processor 701 is used for calling logical instructions in the memory 702 to execute the following method:

when video message information and an identifier of a called terminal that are sent by a calling terminal are received, saving the video message information; sending the video message information to the called terminal upon detecting that the called terminal is online.

By referring to FIG. 2, another embodiment of the present disclosure discloses a computer program, including program codes for executing the following operations:

when video message information and an identifier of a called terminal that are sent by a calling terminal are received by a server, saving the video message information;

sending the video message information to the called terminal upon detecting that the called terminal is online.

FIGS. 6-7 are schematic diagrams of a hardware structure of an electronic device for executing a processing method of list item operations provided by the embodiments of the disclosure. The device includes: one or more processors and a memory, with one processor as an example in FIGS. 6-7.

The device for executing a processing method of list item operations provided by the embodiments of the disclosure may also include: an input device and an output device.

As a non-volatile computer-readable storage medium, the memory is available for storing non-volatile software programs, non-volatile computer-executable programs and modules, such as program instructions/modules corresponding to the processing method of list item operations in the embodiments of the present disclosure. By running non-volatile software programs, instructions and modules stored in the memory, the processor executes various function applications and data processing of a server, i.e., achieving the processing method of list item operations in the above method embodiments.

The memory may include a program storage region and a data storage region, wherein the program storage region is available for storing an operating system, and at least one functionally required application; the data storage region is available for storing data created according to the use of a processing device of list item operations, and the like. In addition, the memory may include a high-speed random access memory, and may also include a non-volatile memory, such as at least one magnetic disk storage device, a flash memory device, or other non-volatile solid-state storage devices. In some embodiments, the memory optionally includes memories remotely set with respect to the processor; these remote memories are connectable to the processing device of list item operations by means of networks. Examples of the networks include, but are not limited to, Internet, Intranet, LAN, mobile communication networks and combinations thereof.

The input device is capable of receiving input digit or character information, and producing key signal inputs related to user settings and function control of the processing device of list item operations. The output device may include a display device such as a display screen.

The one or more modules are stored in the memory, and execute the processing method of list item operations in any above method embodiment when executed by the one or more processors.

The products described above are capable of executing the method provided by the embodiments of the present disclosure, and has corresponding function modules for executing the method and beneficial effects. Those technical details not described in detail in the present embodiment may be found in the method provided by the embodiments of the present disclosure.

The electronic device provided by this embodiment of the present disclosure may be present in a plurality of forms, including but not limited to:

(1) Mobile communication equipment: such equipment is characterized by mobile communication functions and mainly intended to provide voice and data communications. Terminals of this type include: smart phones (e.g., iPhone), multimedia mobile phones, functional mobile phones, low-end mobile phones and so on.

(2) Ultra-mobile personal computer equipment: such equipment falls into the category of personal computers, has computing and processing functions, and generally also has a mobile network access characteristic. Terminals of this type include: PDA, MID, UMPC equipment, and the like, for example iPad.

(3) Portable entertainment equipment: such equipment is able to display and play multimedia contents, and includes: audio and video players (e.g., iPod), handheld game players, electronic book readers, and smart toys and portable vehicle-mounted navigation equipment.

(4) Servers: they are equipment providing computing service. Components of a server include a processor, a hard disk, a memory, a system bus and the like. The architecture of a server is similar to that of a general-purpose computer; however, since servers are required to provide highly reliable services, requirements in such aspects as processing ability, stability, reliability, safety, extendibility and manageability are relatively high.

(5) Other electronic devices having the function of data interaction.

The embodiment of the present disclosure provides a non-volatile computer storage medium on which computer-executable instructions available for executing the processing method of list item operations in any method embodiment described above are stored, wherein the storage medium can be a magnetic disk, an optical disk, a read-only memory (ROM), a random access memory (RAM) or the like.

The device embodiments described above are merely schematic, in which units described as separate parts may be or may be not physically separated from one another, and parts displayed as units may be or may be not physical units, i.e., may be located at one place or distributed to a plurality of network units. Part or all of the modules therein may be selected according to actual requirements to achieve the objectives of the solutions in the present embodiment.

According to the above description of the embodiments, a person skilled in the art can clearly understand that various embodiments may be implemented by means of software in combination with a necessary general-purpose hardware platform, and of course, may also be implemented by means of hardware. Based on such understanding, the above technical solutions substantially or the parts making a contribution to the prior art may be embodied in the form of a software product, which can be stored in a computer-readable storage medium, such as an ROM/RAM, a magnetic disk, an optical disk or the like, and which includes a plurality of instructions for causing a computer device (which can be a personal computer, a server, a network device or the like) to execute various embodiments or the method described in some parts of the embodiments.

Finally, it should be noted that the above embodiments are merely intended to illustrate, rather than limit, the technical solutions of the embodiments of the present disclosure. Although the embodiments of the present disclosure are illustrated in detail with reference to the aforementioned embodiments, a person of ordinary skill in the art should understand that modifications may still be made to the technical solutions recorded in the aforementioned embodiments or equivalent substitutions may be made to part of or all technical features therein; these modifications and substitutions do not cause the nature of the corresponding technical solutions to depart from the scope of the technical solutions in the embodiments of the present disclosure.

What is claimed is:

1. A method for leaving a video message, performing the method at an electronic device, comprising
acquiring video message information of a calling terminal when a user determines to leave a video message;
sending the video message information and an identifier of a called terminal to a server, such that the server sends the video message information to the called terminal.

2. The method according to claim 1, wherein the step of acquiring the video message information of the calling terminal comprises:
acquiring data of a camera and a microphone of the calling terminal to obtain the video message information.

3. The method according to claim 1, before acquiring the video message information of the calling terminal when the user determines to leave the video message, further comprising:
sending a prompt message for prompting the user to leave a video message if the called terminal does not respond to a calling request sent by the calling terminal within a first preset time period.

4. The method according to claim 3, before sending the prompt message for prompting the user to leave the video message, further comprising:
detecting whether a first message sent by the server is received after the calling terminal sends the calling request to the server, wherein the first message is a message indicating no response to the calling request;
determining that the called terminal does not respond to the calling request within the first preset time if the first message is received, and executing the step of sending the prompt message for prompting the user to leave the video message.

5. A method for leaving a video message, performing the method at an electronic device, comprising:
when a server receives video message information and an identifier of a called terminal that are sent by a calling terminal, saving the video message information;
sending the video message information to the called terminal upon detecting that the called terminal is online.

6. The method according to claim 5, before saving the video message information when the server receives the video message information and the identifier of the called terminal that are sent by the calling terminal, further comprising:
when the server receives a calling request sent by the calling terminal, sending the calling request to the called terminal;
sending a first message to the calling terminal if the called terminal does not respond to the calling request within a first preset time period, such that the calling terminal prompts a user to leave a video message, wherein the first message is a message indicating no response to the calling request.

7. The method according to claim 5, further comprising:
deleting the video message information if the called terminal is not online within a second preset time period.

8. An electronic device, comprising:
at least one processor; and
a memory communicably connected with the at least one processor for storing instructions executable by the at least one processor, wherein execution of the instructions by the at least one processor causes the at least one processor to:
acquire video message information of a calling terminal when a user determines to leave a video message;
send the video message information and an identifier of a called terminal to a server, such that the server sends the video message information to the called terminal.

9. The device according to claim 8, wherein the processor is further configured to:
acquire data of a camera and a microphone of the calling terminal to obtain the video message information.

10. The device according to claim 8, the processor is further configured to:
when the called terminal does not respond to a calling request sent by the calling terminal within a first preset time period, send a prompt message for prompting the user to leave a video message.

11. The device according to claim 10, the processor is further configured to:
detect whether a first message sent by the server is received after sending the calling request to the server, wherein the first message is a message indicating no response to the calling request;
determine that the called terminal does not respond to the calling request within the first preset time if the first message is received.

12. An electronic device, comprising:
at least one processor; and
a memory communicably connected with the at least one processor for storing instructions executable by the at least one processor, wherein execution of the instructions by the at least one processor causes the at least one processor to:
receive video message information and an identifier of a called terminal that are sent by a calling terminal;
a saving unit configured to save the video message information;
send the video message information to the called terminal upon detecting that the called terminal is online.

13. The device according to claim 12, the processor is further configured to:
send a calling request sent by the calling terminal to the called terminal when the calling request is received;
send a first message to the calling terminal when the called terminal does not respond to the calling request within a first preset time period, such that the calling terminal prompts a user to leave a video message, wherein the first message is a message indicating no response to the calling request.

14. The device according to claim 12, the processor is further configured to:
delete the video message information if the called terminal is not online within a second preset time period.

15. A non-transitory computer-readable storage medium storing executable instructions that, when executed by an electronic device with a touch-sensitive display, cause the electronic device to:
acquire video message information of a calling terminal when a user determines to leave a video message;
send the video message information and an identifier of a called terminal to a server, such that the server sends the video message information to the called terminal.

16. The non-transitory computer-readable storage medium according to claim 15, wherein the electronic device is further configured to:
acquire data of a camera and a microphone of the calling terminal to obtain the video message information.

17. The non-transitory computer-readable storage medium according to claim 15, the electronic device is further configured to:
when the called terminal does not respond to a calling request sent by the calling terminal within a first preset time period, send a prompt message for prompting the user to leave a video message.

18. The non-transitory computer-readable storage medium according to claim 17, the electronic device is further configured to:
detect whether a first message sent by the server is received after sending the calling request to the server, wherein the first message is a message indicating no response to the calling request;
determine that the called terminal does not respond to the calling request within the first preset time if the first message is received.

19. A non-transitory computer-readable storage medium storing executable instructions that, when executed by an electronic device with a touch-sensitive display, cause the electronic device to:
when video message information and an identifier of a called terminal that are sent by a calling terminal are received by a server, saving the video message information;
sending the video message information to the called terminal upon detecting that the called terminal is online.

20. The non-transitory computer-readable storage medium according to claim 19, the electronic device is further configured to:
send a calling request sent by the calling terminal to the called terminal when the calling request is received;
send a first message to the calling terminal when the called terminal does not respond to the calling request within a first preset time period, such that the calling terminal prompts a user to leave a video message, wherein the first message is a message indicating no response to the calling request.

21. The non-transitory computer-readable storage medium according to claim 19, the electronic device is further configured to:
delete the video message information if the called terminal is not online within a second preset time period.
